(19) United States
(12) Patent Application Publication
(10) Pub. No.: US 2015/0019239 A1
(43) Pub. Date: Jan. 15, 2015

(54) IDENTIFYING TARGET PATIENTS FOR NEW DRUGS BY MINING REAL-WORLD EVIDENCE

(71) Applicant: INTERNATIONAL BUSINESS MACHINES CORPORATION, Armonk, NY (US)

(72) Inventors: Shahram Ebadollahi, White Plains, NY (US); Jianying Hu, Bronx, NY (US); Jimeng Sun, White Plains, NY (US); Fei Wang, Ossining, NY (US); Ping Zhang, White Plains, NY (US)

(73) Assignee: INTERNATIONAL BUSINESS MACHINES CORPORATION, Armonk, NY (US)

(21) Appl. No.: 13/970,262

(22) Filed: Aug. 19, 2013

Related U.S. Application Data
(63) Continuation of application No. 13/938,664, filed on Jul. 10, 2013.

(51) Int. Cl. G06F 19/00

(52) U.S. Cl. CPC G06F 19/3437
USPC 705/2

(57) ABSTRACT

Systems and methods for patient identification include identifying a set of mature drugs similar to a target drug using a processor based on a drug similarity measure. A plurality of outcome models are constructed for each mature drug in the set based on real-world evidence, the plurality of outcome models representing a patient response to each mature drug. A patient response to the target drug is predicted based on the outcome models to identify patients for the target drug.

### RELATED APPLICATION INFORMATION

This application is a Continuation application of copending U.S. patent application Ser. No. 13/938,664 filed on Jul. 10, 2013, incorporated herein by reference in its entirety.

### BACKGROUND

1. Technical Field

The present invention relates to identifying target patients for new drugs, and more particularly to identifying target patients for new drugs by identifying mature drugs that are similar using real-world evidence.

2. Description of the Related Art

Although randomized clinical trials remain the gold standard for demonstrating drug safety and efficacy, the inherent limitations of their data—small sample size, controlled environment, and focus on short-term outcomes—means healthcare stakeholders (e.g., regulators, payers, providers, patients, and pharmaceutical companies) need to use real-world evidence to make informed decisions. Different individuals given the same drug show a wide range of responses, ranging from no detectable change to grossly excessive reactions of various kinds. These reactions are due to many factors, such as age, sex, body weight, nutrition, alcohol, smoking, pregnancy, genetic factors, environment, and pathological conditions.

Personalized medicine is a medical model that proposes the customization of healthcare, with decisions and practices being tailored to the individual patient by use of patient specific information. Most existing personalized medicine approaches focus on genetic information (e.g., genetic biomarkers, sequencing, microarray) to distinguish different patient groups. Such genetic information is not yet widely available and insufficient since it only addresses one of many factors affecting response to medication. Existing approaches using real-world evidence for personalized medicine rely on large amounts of real-world data on the target drug itself, which may not be available for new drugs.

### SUMMARY

A method for patient identification includes identifying a set of mature drugs similar to a target drug using a processor based on a drug similarity measure. A plurality of outcome models are constructed for each mature drug in the set based on real-world evidence, the plurality of outcome models representing a patient response to each mature drug. A patient response to the target drug is predicted based on the outcome models to identify patients for the target drug.

A system for patient identification includes a similarity module configured to identify a set of mature drugs similar to a target drug using a processor based on a drug similarity measure. A modeling module is configured to construct a plurality of outcome models for each mature drug in the set based on real-world evidence, the plurality of outcome models representing a patient response to each mature drug. A prediction module is configured to predict a patient response to the target drug based on the outcome models to identify patients for the target drug.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a high-level block/flow diagram showing a system/method for identifying target patients for a target drug, in accordance with one illustrative embodiment;

FIG. 2 is a block/flow diagram showing a system/method for target patient identification, in accordance with one illustrative embodiment;

FIG. 3 is a high-level block/flow diagram showing a system/method for identifying target patients for a single agent combination, in accordance with one illustrative embodiment; and

FIG. 4 is a block/flow diagram showing a system/method for target patient identification, in accordance with one illustrative embodiment.

### DETAILED DESCRIPTION OF PREFERRED EMBODIMENTS

In accordance with the present principles, systems and methods for identifying target patients for new drugs by mining real-world evidence are provided. For a cohort of patients and associated patient data, a set of mature drugs are identified that are similar to a target drug based on a drug similarity measure. The target drug is preferably a new drug or candidate drug, or may be a combination of a new drug and a mature drug. The drug similarity measure may be based on chemical structure, side effects, target protein, and/or annotation hierarchy distance. A plurality of patient outcome models are constructed for each mature drug in the set based on the real-world evidence, such as patient medical events. The patient outcome models represent a patient response to each mature drug. A patient response to the new drug is predicted based on the outcome models of the mature drugs in the set.

The present principles provide for personalization of new drugs by combining real-world evidence with drug similarity analysis. The present principles leverage a large amount of real-world evidence, which are available for mature drugs, to derive information relevant for the target drug.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

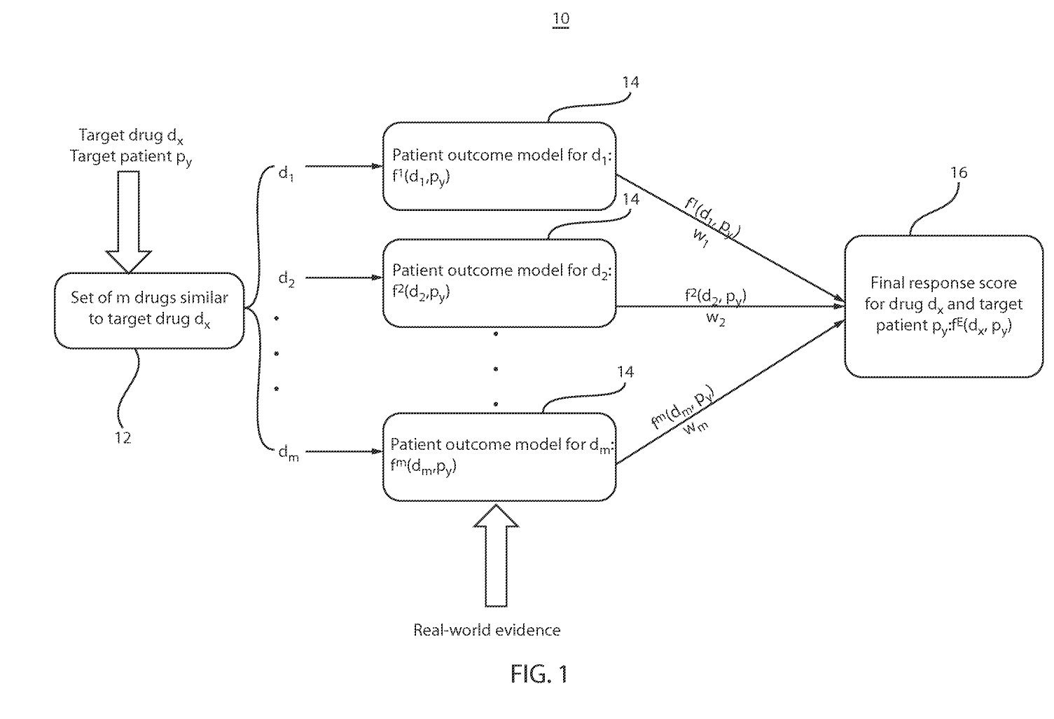

Referring now to the drawings in which like numerals represent the same or similar elements and initially to FIG. 1, a high-level block/flow diagram for a system/method for identifying target patients for a target drug 10 is illustratively depicted in accordance with one embodiment. In block 12, for a target drug dₓ and a target patient p_{y}, a set of m drugs are identified that are similar to the target drug dₓ. Patient outcome models 14 are constructed for each of the drugs in the set of m similar drugs using real-world evidence, which may be mined from patient data indicating medical events. The patient outcome models 14 measure the relationship between patient features and outcomes when the patient takes a drug. The patient outcome models 14 are employed to generate response scores f^{m} (dₘ, p_{y}) for each respective drug in the set with respect to the target patient p_{y}. The response scores indicate the likelihood of a positive response to each drug in the set for the target patient p_{y}. The response scores for the set of m drugs are combined to provide a final response score 16 indicating the likelihood of a positive response to the target drug dₓ for the target patient p_{y}. The response scores are combined by summing weighted response scores for each drug in the set. The weight wₘ given to each response score is based on the similarity measure of its associated drug to the target drug dₓ.

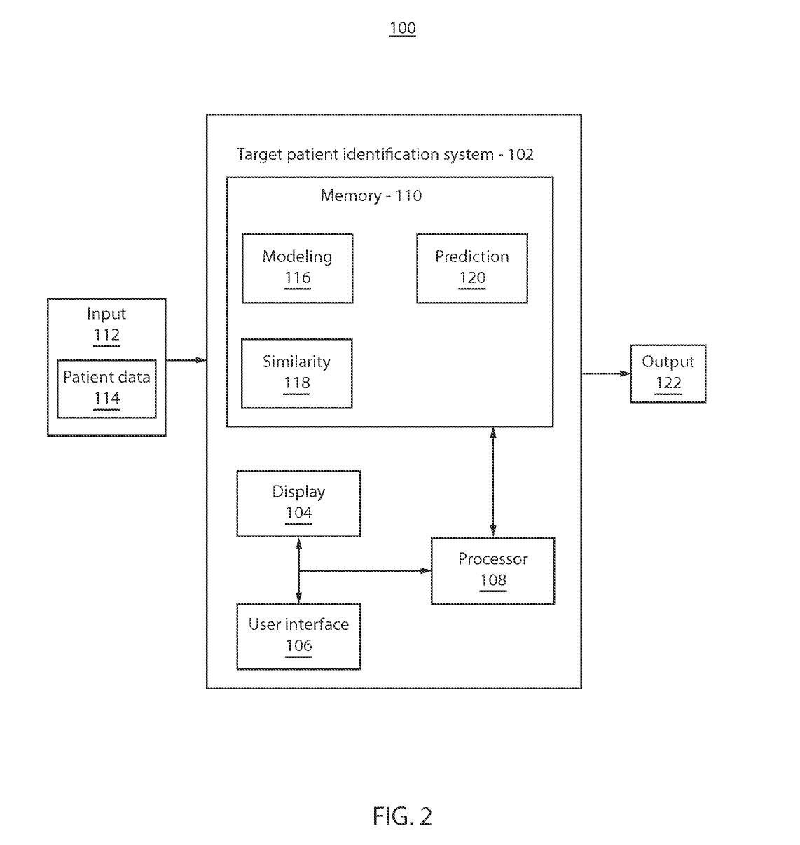

Referring now to FIG. 2, with continued reference to FIG. 1, a block/flow diagram for a system for target patient identification 100 is illustratively depicted in accordance with one embodiment. The system 100 provides a new methodology for the personalization of new drugs by combining real-world evidence with drug similarity analysis. The system 100 leverages large amounts of real-world data or evidence available for mature drugs to derive information relevant for a new drug.

It should be understood that embodiments of the present principles may be applied in a number of different applications. For example, the present invention may be discussed throughout this application as in terms of healthcare. However, it should be understood that the present invention is not so limited. Rather, embodiments of the present principles may be applicable in a number of different fields. For example, the present principles may be employed in an insurance setting. Other applications may also be applied within the context of the present invention.

The system 100 may include a system or workstation 102. The system 102 preferably includes one or more processors 108 and memory 110 for storing patient data, applications, modules and other data. The system 102 may also include one or more displays 104 for viewing. The displays 104 may permit a user to interact with the system 102 and its components and functions. This may be further facilitated by a user interface 106, which may include a mouse, joystick, or any other peripheral or control to permit user interaction with the system 102 and/or its devices. It should be understood that the components and functions of the system 102 may be integrated into one or more systems or workstations, or may be part of a larger system or workstation.

The system 102 may receive input 112, which may include real-world evidence, such as, e.g., patient data 114, drug feature vector, etc. which may be stored in memory 110. Real-world evidence is evidence derived using data collected outside the controlled constraints of conventional clinical trials to evaluate what is happening in normal clinical practice. Patient data 114 may include patient event data and associated outcomes for each patient in a cohort of patients. Patient event data may include, e.g., diagnoses, labs, patient demographics, pharmacy and medications, procedures, etc. for each patient. The system 102 employs feature extraction to process the patient event data into a patient feature vector for each patient in the cohort, which may be stored in memory 110. Patient outcomes are associated with each patient feature vector. Outcomes may be segmented into, e.g., positive and negative outcomes. For example, a disease that is under control may be a positive outcome while a disease that is not under control may be a negative outcome. Other types of outcomes are also contemplated.

Feature extraction to process patient event data into a patient feature vector may include, for each patient, anchoring an index date and constructing a feature vector from the observation window, which may be defined as the fixed size time window right before the index date. For a patient, the index date is preferably the diagnosis date, while for a control patient, the index date may be the diagnosis date of his/her matching case patient. The patient feature vector preferably includes statistical measures derived from the longitudinal medical events during the observation window. In particular, feature values are derived from the corresponding patient data records from the observation window for the patient. For discrete events (e.g., diagnoses, medication, symptoms), the number of occurrences may be used as the feature value. For continuous events (e.g., lab measures), the average of those measures in the observation windows after removing invalid and noisy outliers may be used as the feature value. Other approaches to feature extraction may also be employed within the context of the present principles.

The modeling module 116 is configured to construct patient outcome models for each mature drug to model the response of a target patient p_{y} to the mature drugs based upon real-world evidence. For each mature drug, a set of patients is identified who take the mature drug using the patient data 114. Drug outcomes are then identified for all patients in the set. Drug outcomes may be, e.g., positive response, negative response, no response, etc. For each mature drug, a patient outcome model f is constructed based on the patient event data of the patient data 114. By using the patient feature vector (x) and outcome information (y), a model f is trained for each mature drug as y=f(x).

In one embodiment, the creation of the patient outcome model is based on the standard supervised learning models. Patient feature vectors may be used to train the patient outcome model. Based on features and labels of the training set, machine learning algorithms (e.g., regularized logistic regression, etc.) may be employed to learn parameters of the model. When new data is received without labels, the model can be applied to predict the labels.

Similarity module 118 is configured to determine a set of m mature drugs similar to the target drug based upon one or more drug similarity measures. The set of m mature drugs may be determined as the top m most similar mature drugs, the mature drugs within a similarity measure threshold, etc. The drug similarity measures may include, e.g., a chemical structure similarity, a side-effect similarity, a target protein similarity, an annotation similarity, etc. Other drug similarity measures may also be employed in accordance with the present principles.

In one embodiment, where the target drug dₓ is a new drug, such as a drug candidate, only its chemical structure is known. Thus, its chemical property is preferably employed to measure drug similarities involving new drugs. The pairwise similarity of drugs sim(dₓ,d_{y}) is calculated based on the 2-dimensional (2D) chemical fingerprint descriptor of each drug's chemical structure (e.g., as found in PubChem). That is, each drug d is represented by a binary fingerprint h(d) in which each bit indicates the presence of a predefined chemical structure fragment. Then, the pairwise similarity between two drugs dₓ and d_{y} is computed as the Tanimoto coefficient of their fingerprints:

$$sim ( {d}_{x} , {d}_{y} ) = \frac{h ( {d}_{x} ) \cdot h ( {d}_{y} )}{\vert h ( {d}_{x} ) \vert + \vert h ( {d}_{y} ) \vert - h ( {d}_{x} ) \cdot h ( {d}_{y} )} \qquad ( 1 )$$

where |h(dₓ)| and |h(d_{y})| are the counts of structure fragments in drugs dₓ and d_{y}, respectively. The dot product h(dₓ)•h(d_{y}) represents the number of structure fragments shared by the two drugs. The sim score is in the [0,1] range, where 0 indicates that the drugs are not similar and 1 indicates that the drugs are the same.

In another embodiment, where additional information is known about the target drug (e.g., such as a mature drug), the feature vector of drugs with additional information can be extended (based on, e.g., side effect, target protein, annotation, etc.) and the similarity measure can be calculated using the Tanimoto coefficient. In a side effect similarity measure, drug side effects can be obtained, e.g., from the SIDER (Side Effect Resource) database. The similarity measure can define similarity between drugs according to the Jaccard score between their known side effects. In a target protein similarity measure, target protein similarity can be measured based on a Smith-Waterman sequence alignment score between the corresponding drug-related target protein. For normalization, the Smith-Waterman score is divided by the geometric mean of the scores obtained from aligning each sequence against itself. In an annotation similarity measure, annotation similarity is measured based on the Anatomical Therapeutic Chemical (ATC) classification system of the World Health Organization (WHO). This pharmaceutical coding system divides drugs into different groups according to the organ or system on which they act and/or their therapeutic and chemical characteristics. The similarity between drugs is defined as their Resnik distance in the ATC hierarchical structure. Other similarity measures may also be employed. The similarity scores from different information sources are then integrated into a meta-similarity by logistic regression.

The prediction module 120 is configured to predict a patient response to the target drug dₓ based on the patient outcome model for the set of m mature drugs. For each drug in the set of m mature drugs, the constructed patient outcome models are employed to generate response scores using the patient data 114. The patient outcome models measure the relationship between the patient feature vector and the outcomes when the patient takes a drug. The response scores indicate the likelihood of a positive reaction to the respective mature drug for the target patient p_{y}. The response scores are then combined to obtain a final response score f^{E} (dₓ,p_{y}) indicating the likelihood of a positive response to the target drug dₓ for the target patient p_{y}. Response scores are preferably combined by summing weighted response scores for each of the mature drugs in the set using drug similarity as the weight w. The final response score is calculated as follows:

$${f}^{E} ( {d}_{x} , {p}_{y} ) = {\sum }_{i = 1}^{m} {w}_{i} {f}^{i} ( {d}_{i} , {p}_{y} ) \\ w \geq 0 , {w}^{T} 1 = 1 , w \sim s \qquad ( 2 )$$

where wᵢ is the weight for drug i, fⁱ(dᵢ, p_{y}) is the response score for drug i and target patient p_{y}, and s is the drug similarity vector.

The final response scores may be used to predict a patient response to the target drug. Patients predicted to have a, e.g., positive response to the target drug may be selected. Selection of patients by score may be based on a threshold, a top x scoring patients, etc. Other approaches may also be employed. The selected patients may be part of output 122.

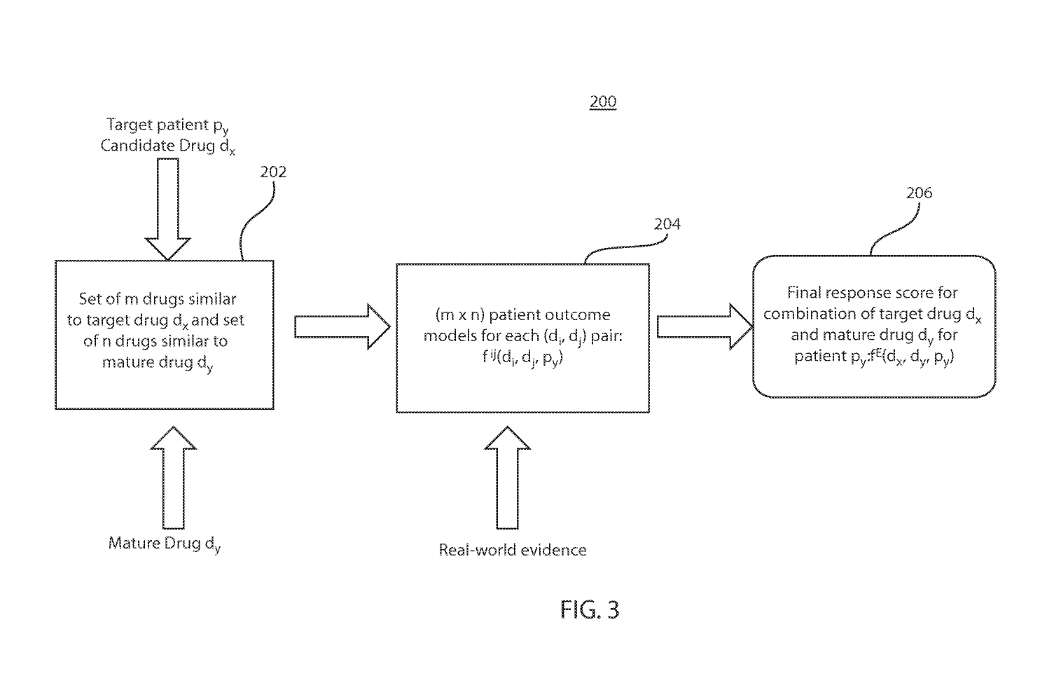

In a particularly useful embodiment, where a new (target) drug is administered in combination with a mature drug, the present principles may be employed to identify similar mature drugs to the target drug and the mature drug to thereby identify target patients. Referring now to FIG. 3, a high-level block/flow diagram for a system/method for identifying target patients for a single agent combination 200 is illustratively depicted in accordance with one embodiment. In block 202, a set of m drugs similar to the target drug dₓ and a set of n drugs similar to mature drug d_{y} are identified. In block 204, (m×n) patient outcome models are constructed for each drug combination (dᵢ, dⱼ) using real-world evidence, which may be mined from patient data. The patient outcome models 204 are employed to generate a response score f^{ij} (dᵢ, dⱼ, p_{y}) for each drug combination with respect to the target patient p_{y}. The response scores f^{ij} indicate the likelihood of a positive response to the combination of the target drug dₓ and mature drug d_{y} for the target patient p_{y}. A final response score f^{E}(dᵢ, dⱼ, p_{y}) is provided by combining the weighted response scores for each drug combination. The weight wₘ associated with each response score is preferably based on the similarity measure of the drugs. The final response score for a single agent combination is provided as follows:

$${f}^{E} ( {d}_{i} , {d}_{j} , {p}_{y} ) = {\sum }_{i = 1}^{m} {\sum }_{j = 1}^{n} {w}_{ij} {f}^{ij} ( {d}_{i} , {d}_{j} , {p}_{y} ) \qquad ( 3 )$$

The present principles provide for the personalization of new drugs by combining real-world evidence with drug similarity analysis. Large amounts of real-world evidence is leveraged for mature drugs to derive information relevant for a new drug to thereby identify target patients. The present principles may further be employed for the purpose of improving clinical trial efficiency. The collective response scores of patients can be used to judge whether a trial should continue to the next phase, or terminate due to a small likelihood of success. Other applications are also contemplated in accordance with the present principles.

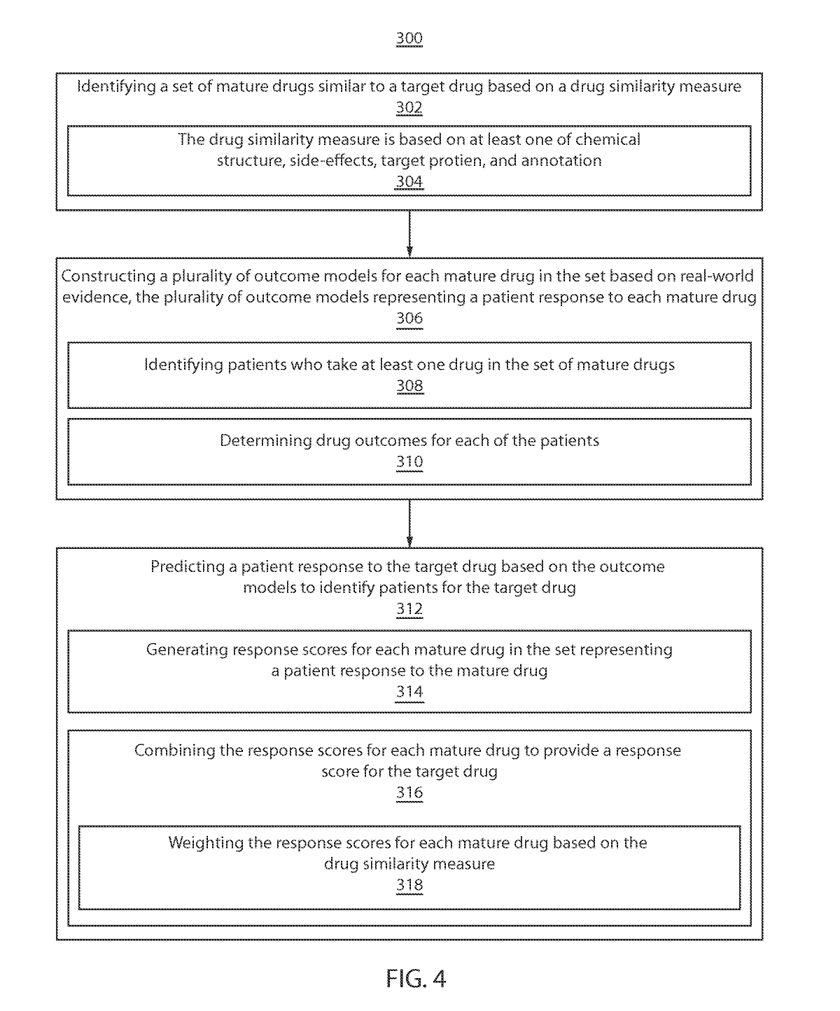

Referring now to FIG. 4, a block/flow diagram of a method for target patient identification 300 is illustratively depicted in accordance with one embodiment. In block 302, a set of mature drugs are identified that are similar to a target drug based on a drug similarity measure. The target drug is preferably a new drug. In some embodiments, the target drug is a combination of a new drug and a mature drug. In block 304, the drug similarity measure may be based on at least one of chemical structure, side effects, target protein, and annotation. Preferably, where the target drug is a new drug, the drug similarity measure is based on chemical structure. Where the target drug is a mature drug, the drug similarity measure is preferably based on at least one of chemical structure, side effects, target protein, and annotation.

In block 306, a plurality of outcome models are constructed for each mature drug in the set based on real-world evidence. The plurality of outcome models represent a patient response to each mature drug. Real-world evidence is evidence derived using data collected outside the controlled constrains of conventional clinical trials to evaluate what is happening in normal clinical practice. Real-world evidence may include patient data, such as diagnoses, lab results, patient demographics, pharmacy and medications, procedures, etc. In block 308, constructing the plurality of outcome models may include identifying patients who take at least one of the drugs in the set of mature drugs. In block 310, drug outcomes are determined for each of the identified patients.

In block 312, a patient response to the target drug is predicted based on the outcome models to identify patients for the target drug. In block 314, predicting includes generating response scores for each mature drug in the set representing a patient response to the mature drug. In block 316, the response scores for each mature drug are combined to provide a response score for the target drug. The response scores for each mature drug are preferably combined by summing weighted response scores for each mature drug. In block 318, the response scores are weighted for each mature drug based on the drug similarity measure.

Having described preferred embodiments of a system and method for identifying target patients for new drugs by mining real-world evidence (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer readable storage medium comprising a computer readable program for patient identification, wherein the computer readable program when executed on a computer causes the computer to perform the steps of:
identifying a set of mature drugs similar to a target drug based on a drug similarity measure;
constructing a plurality of outcome models for each mature drug in the set based on real-world evidence, the plurality of outcome models representing a patient response to each mature drug; and
predicting a patient response to the target drug based on the outcome models to identify patients for the target drug.

2. A system for patient identification, comprising:
a similarity module configured to identify a set of mature drugs similar to a target drug using a processor based on a drug similarity measure;
a modeling module configured to construct a plurality of outcome models for each mature drug in the set based on real-world evidence, the plurality of outcome models representing a patient response to each mature drug; and
a prediction module configured to predict a patient response to the target drug based on the outcome models to identify patients for the target drug.

3. The system as recited in claim 2, wherein the drug similarity measure is based on at least one of chemical structure, side effects, target proteins and annotation hierarchical distance.

4. The system as recited in claim 2, wherein the modeling module is further configured to identify patients who take at least one drug from the set of mature drugs.

5. The system as recited in claim 4, wherein the modeling module is further configured to determine drug outcomes for each of the patients.

6. The system as recited in claim 2, wherein the prediction module is further configured to generate response scores for each mature drug in the set representing a patient response to the mature drug.

7. The system as recited in claim 6, wherein the prediction module is further configured to combine the response scores to provide a response score for the target drug, wherein the response scores are weighted based on the drug similarity measure.

8. The system as recited in claim 7, wherein the prediction module is further configured to combine the response scores for all of the patients.

9. The system as recited in claim 7, wherein the prediction module is further configured to combine response scores based on features of the patients.

10. The system as recited in claim 2, wherein the target drug includes a combination of a new drug and a mature drug.
